(19) United States
(12) Patent Application Publication
(10) Pub. No.: US 2026/0132314 A1
(43) Pub. Date: May 14, 2026

(54) ADHESIVE TAPE

(71) Applicant: ETERNAL MATERIALS CO., LTD., KAOHSIUNG (TW)

(72) Inventors: AN-I TSAI, KAOHSIUNG (TW); YU-PENG HU, KAOHSIUNG (TW); YU-HSUN LI, KAOHSIUNG (TW)

(73) Assignee: ETERNAL MATERIALS CO., LTD., KAOHSIUNG (TW)

(21) Appl. No.: 19/323,015

(22) Filed: Sep. 9, 2025

(30) Foreign Application Priority Data
Nov. 13, 2024 (TW) 113143629

(51) Int. Cl. C09J 7/30

(52) U.S. Cl. CPC C09J 7/30; C09J 2301/414; C09J 2301/416

(57) ABSTRACT

The present disclosure provides an adhesive tape comprising a substrate and an adhesive composition disposed on the substrate. The adhesive composition comprises an acrylic resin, a crosslinking agent, and a Norrish-type I photoinitiator. After UV radiation curing at a wavelength of 365 nm, the adhesive composition with a volume of approximately 36 mm³ generates a fragment content of the Norrish-type I photoinitiator in a sealed space of 20 mL under standard conditions, measured by gas chromatography-mass spectrometry (GC-MS), which is less than 10 ppm.

### CROSS-REFERENCE TO RELATED APPLICATIONS

This application claims priority under 35 U.S.C. § 119 (a) to Taiwan Patent Application No. 113143629, entitled “ADHESIVE TAPE,” filed Nov. 13, 2024, in the Taiwan Intellectual Property Office. The entire disclosure of that application is incorporated herein by reference.

### BACKGROUND

### 1. Field of the Invention

The present disclosure relates to an adhesive composition. The present disclosure relates to an adhesive tape including an adhesive composition, and in particular, to a light radiation release dicing tape for semiconductor processes.

### 2. Description of the Related Art

A light radiation release dicing tape is used to hold a semiconductor wafer in place in a dicing/separation process. Before light radiation, the tape has a strong adhesive force, which cannot cause the problem of movement or peeling off. After light radiation, the tape is easy to peel off as the adhesive force is reduced, so as to avoid mechanical damage to a target product due to the adhesion of the tape. There is a need to improve the performance of the light radiation release dicing tape in the art.

### SUMMARY

The present disclosure provides a new adhesive tape including a substrate and an adhesive composition disposed on the substrate. The adhesive composition includes an acrylic resin, a crosslinking agent, and a Norrish-type I photoinitiator. After UV radiation curing at a wavelength of 365 nm, the adhesive composition with a volume of approximately 36 mm³ generates a fragment content of the Norrish-type I photoinitiator in a sealed space of 20 mL under standard conditions, measured by gas chromatography-mass spectrometry (GC-MS), which is less than 10 ppm.

### DETAILED DESCRIPTION

For ease of understanding of the content disclosed herein, several terms are defined hereinafter.

All numbers used in this specification and in the scope of the patent application to express contents, proportions, physical characteristics, and the like should be understood as being modified by the term “approximately” or “about” in all cases. As used herein, the term “approximately” or “about” means an acceptable error in a particular value determined by a person generally skilled in the art, depending in part on how the value is measured or determined.

As used herein, unless specifically limited, the singular forms “a,” “an,” and “the” include their plural forms. Any and all embodiments and exemplary words (“for example” and “such as”) herein are intended to highlight the present disclosure only but are not intended to constitute a limitation on the scope of the present disclosure. The words used in this specification should not be regarded as implying that any unclaimed methods and conditions may constitute necessary features in the implementation of the present disclosure.

The word “or” involved in a list of two or more items covers the interpretation of all the following words: any one of the items in the list, all of the items in the list, and any combination of the items in the list.

All ranges disclosed herein should be understood as covering any and all sub-ranges included therein. For example, the range “1 to 10” should be regarded as including any and all sub-ranges between the minimum value 1 and the maximum value 10 and including the minimum value 1 and the maximum value 10, that is, all sub-ranges that start with 1 or a minimum value greater than 1 and end with 10 or a maximum value less than 10, such as 1 to 6.7, 3.2 to 8.1, or 5.5 to 10, and any number within this range, such as 2.6, 4.7, or 7.3.

There are at least two requirements for the performance of a light radiation release dicing tape in the present disclosure. (1) The tape can securely hold a wafer in place in a dicing process. (2) The tape can be easily peeled off from the wafer after light radiation. The foregoing requirements can be achieved by using a light radiation adhesive composition. This adhesive composition is cured after light radiation to be formed and hardened, making the tape lose adhesion (namely, debonding). However, in the process of curing the adhesive composition by light radiation, a photoinitiator contained in the adhesive composition decomposes and releases a fragmented photoinitiator in the form of gas (hereinafter referred to as “fragments of the photoinitiator”), causing outgassing of the adhesive composition to contaminate the wafer, which is not conducive to the stability of semiconductor processes and the reliability of a final device. In addition, the fragments of the photoinitiator may also be released during wafer cleaning, so the fragments of the photoinitiator are dispersed in a solvent (for example, an aqueous solution of tetramethylammonium hydroxide (TMAH) or NH₄OH), and consequently remain on the wafer.

To achieve the foregoing objectives, the present disclosure provides an adhesive tape including a substrate and the adhesive composition as described herein disposed on the substrate. The adhesive tape is preferably a light radiation release dicing tape for semiconductor processes. The present disclosure further provides an adhesive composition including an acrylic resin, a crosslinking agent, and a photoinitiator.

The following describes in detail the content of the present disclosure:

### Acrylic Resin Component of the Adhesive Composition

The adhesive composition of the present disclosure is mainly based on the acrylic resin. Compared to other resins, the acrylic resin can provide many favorable properties. For example, the acrylic resin has a high adhesive force before UV radiation, and thus can securely adhere to various substrates. However, after UV radiation, polymer chains in the acrylic resin cohere together to form a three-dimensional mesh structure, causing a drastic decrease of the adhesive force, so the tape can be easily and cleanly peeled off. In addition, since the acrylic resin has an extremely low adhesive force after UV radiation, no residual adhesive is left on the substrate, keeping the surface clean. The acrylic resin reacts to UV radiation in a very short time, which can effectively improve work efficiency.

A suitable acrylic resin may include one or more repeating units derived from acrylic or acrylate monomers. The repeating units may have a residue of an acrylic monomer including a group of a radiation-curable carbon-carbon double bond.

The acrylic resin may be a homopolymer or a copolymer. A monomer forming the acrylic resin may include one or more first monomers and one or more second monomers different from the first monomers. The first monomers are selected from the group consisting of alkyl esters of (meth)acrylic acid, cycloalkyl esters of (meth)acrylic acid, and aryl esters of (meth)acrylic acid. The first monomer may be copolymerized with the second monomer to form the acrylic resin, to provide desirable properties such as cohesion or peel strength.

Suitable alkyl esters of (meth)acrylic acid include, for example, but are not limited to: C₁-C₂₀ alkyl esters of (meth)acrylic acid, such as methyl (meth)acrylate, ethyl (meth)acrylate, propyl (meth)acrylate, isopropyl (meth)acrylate, butyl (meth)acrylate, isobutyl (meth)acrylate, sec-butyl (meth)acrylate, tert-butyl (meth)acrylate, pentyl (meth)acrylate, hexyl (meth)acrylate, heptyl (meth)acrylate, octyl (meth)acrylate, isooctyl (meth)acrylate, 2-ethylhexyl (meth)acrylate, nonyl (meth)acrylate, isononyl (meth)acrylate, decyl (meth)acrylate, isodecyl (meth)acrylate, undecyl (meth)acrylate, dodecyl (meth)acrylate, tridecyl (meth)acrylate, tetradecyl (meth)acrylate, pentadecyl (meth)acrylate, hexadecyl (meth)acrylate, heptadecyl (meth)acrylate, or octadecyl (meth)acrylate.

Suitable cycloalkyl esters of (meth)acrylic acid include, for example, but are not limited to: C₃-C₂₀ cycloalkyl esters of (meth)acrylic acid, such as cyclopropyl (meth)acrylate, cyclobutyl (meth)acrylate, cyclopentyl (meth)acrylate, cyclohexyl (meth)acrylate, cycloheptyl (meth)acrylate, cyclooctyl (meth)acrylate, cyclononyl (meth)acrylate, cyclodecyl (meth)acrylate, cycloundecyl (meth)acrylate, cyclododecyl (meth)acrylate, cyclotridecyl (meth)acrylate, cyclotetradecyl (meth)acrylate, cyclopentadecyl (meth)acrylate, cyclohexadecyl (meth)acrylate, cycloheptadecyl (meth)acrylate, or cyclooctadecyl (meth)acrylate.

Suitable aryl esters of (meth)acrylic acid include, for example, but are not limited to: C₆-C₁₂ aryl esters of (meth)acrylic acid, such as phenyl (meth)acrylate.

The first monomer is preferably an alkyl ester of (meth)acrylic acid, such as methyl (meth)acrylate, ethyl (meth)acrylate, propyl (meth)acrylate, isopropyl (meth)acrylate, butyl (meth)acrylate, isobutyl (meth)acrylate, sec-butyl (meth)acrylate, tert-butyl (meth)acrylate, pentyl (meth)acrylate, hexyl (meth)acrylate, heptyl (meth)acrylate, octyl (meth)acrylate, or isooctyl (meth)acrylate.

The second monomer is based on, for example, but is not limited to, the following monomers: a carboxyl-containing monomer, an anhydride-containing monomer, a hydroxyl-containing monomer, a sulfonate-containing monomer, a phosphate-containing monomer, an amide monomer, a cyano-containing monomer, an amino-containing monomer, an epoxy-containing monomer, an alkenyl monomer, a styrene monomer, a vinyl ester monomer, a vinyl ether monomer, an isocyanate-containing monomer, or a monomer with a ring including one or more nitrogen atoms. In some embodiments, the second monomer may include a combination of the following: a carboxyl-containing monomer, a hydroxyl-containing monomer, and an isocyanate-containing monomer.

A suitable carboxyl-containing monomer includes, for example, but is not limited to: (meth)acrylic acid, 2-carboxyethyl (meth)acrylate, carboxypentyl (meth)acrylate, itaconic acid, cis-butenedioic acid, trans-butenedioic acid, crotonic acid, or isocrotonic acid.

A suitable anhydride-containing monomer includes, for example, but is not limited to: maleic anhydride or itaconic anhydride.

A suitable hydroxyl-containing monomer includes, for example, but is not limited to: 2-hydroxyethyl (meth)acrylate, 2-hydroxypropyl (meth)acrylate, 4-hydroxypropyl (meth)acrylate, 6-hydroxyhexyl (meth)acrylate, 8-hydroxyoctyl (meth)acrylate, 10-hydroxydecyl (meth)acrylate, 12-hydroxylauryl (meth)acrylate, (4-(hydroxymethyl)cyclohexyl) methyl (meth)acrylate, vinyl alcohol, allyl alcohol, 2-hydroxyethyl vinyl ether, 2-hydroxypropyl vinyl ether, 4-hydroxybutyl vinyl ether, ethylene glycol monovinyl ether, diethylene glycol monovinyl ether, propylene glycol monovinyl ether, or dipropylene glycol monovinyl ether.

A suitable sulfonate-containing monomer includes, for example, but is not limited to: styrenesulfonic acid, allylsulfonic acid, 2-(meth)acrylamido-2-methylpropanesulfonic acid, (meth)acrylamido-propanesulfonic acid, sulfopropyl (meth)acrylate, or (meth)acryloyloxynaphthalene sulfonic acid.

A suitable phosphate-containing monomer includes, for example, but is not limited to: 2-hydroxyethyl acryloylphosphate.

A suitable amide monomer includes, for example, but is not limited to: (meth)acrylamide, N,N-dimethyl (meth)acrylamide, N-butyl (meth)acrylamide, N-hydroxymethyl (meth)acrylamide, N-hydroxymethylpropyl (meth)acrylamide, N-methoxymethyl (meth)acrylamide, or N-butoxymethyl (meth)acrylamide.

A suitable cyano-containing monomer includes, for example, but is not limited to: (meth)acrylonitrile.

A suitable amino-containing monomer includes, for example, but is not limited to: ethyl amine (meth)acrylate, ethyl N,N-dimethylamine (meth)acrylate, or ethyl tert-butylamine (meth)acrylate.

A suitable epoxy-containing monomer includes, for example, but is not limited to: glycidyl (meth)acrylate or methyl glycidyl (meth)acrylate.

A suitable alkenyl monomer includes, for example, but is not limited to: ethylene, propylene, isopropylene, butadiene, or isobutylene.

A suitable styrene monomer includes, for example, but is not limited to: styrene, α-methylstyrene, or vinyltoluene.

A suitable vinyl ester monomer includes, for example, but is not limited to: vinyl acetate or vinyl propionate.

A suitable vinyl ether monomer includes, for example, but is not limited to: methyl vinyl ether or ethyl vinyl ether.

A suitable isocyanate-containing monomer includes, for example, but is not limited to: (meth)acryloyl isocyanate, (meth)acryloyloxy methyl isocyanate, 2-(meth)acryloyloxy ethyl isocyanate, 2-(meth)acryloyloxy propyl isocyanate, 3-(meth)acryloyloxy propyl isocyanate, 4-(meth)acryloyloxy butyl isocyanate, or isocyanic m-propenyl-α,α-dimethylbenzyl ester, preferably 2-(meth)acryloyloxy ethyl isocyanate, which allows the obtained acrylic resin to show improved high-temperature resistance and resistance to debonding.

A suitable monomer with a ring including one or more nitrogen atoms includes, for example, but is not limited to: N-vinyl-2-pyrrolidinone, N-methylvinylpyrrolidinone, N-vinylpyridine, N-vinylpiperidone, N-vinylpyrimidine, N-vinylpiperazine, N-vinylpyrazine, N-vinylpyrrole, N-vinylimidazole, N-vinylazole, N-vinylquinoline, N-vinylcaprolactam, or N-(meth)acryloylmorpholine.

In some embodiments, the second monomer may include a combination of the following: acrylic acid, 2-hydroxyethyl acrylate, and 2-methacryloyloxy ethyl isocyanate, to allow the obtained acrylic resin to show good adhesion before light radiation curing.

The amount of the first monomer is not particularly limited and may be adjusted according to an actual application requirement. In some embodiments, by a total amount of all monomers of the acrylic resin, the amount (proportion) of the first monomer may be about 40 wt % to about 80 wt %, for example, about 40 wt %, 45 wt %, 50 wt %, 55 wt %, 60 wt %, 65 wt %, 70 wt %, 75 wt %, or 80 wt %, preferably about 60 wt % to about 70 wt %.

The amount of the second monomer is not particularly limited and may be adjusted according to an actual application requirement. In some embodiments, by a total amount of all monomers of the acrylic resin, the amount (proportion) of the second monomer may be about 20 wt % to about 60 wt %, for example, about 20 wt %, 25 wt %, 30 wt %, 35 wt %, 40 wt %, 45 wt %, 50 wt %, 55 wt %, or 60 wt %, preferably about 30 wt % to about 40 wt %.

In the second monomer, the amount of the carboxyl-containing monomer is not particularly limited and may be adjusted according to an actual application requirement. In some embodiments, by a total amount of all monomers of the acrylic resin, the amount (proportion) of the carboxyl-containing monomer may be about 0.1 wt % to about 10 wt %, for example, about 0.1 wt %, 0.5 wt %, 1 wt %, 2 wt %, 3 wt %, 4 wt %, 5 wt %, 6 wt %, 7 wt %, 8 wt %, 9 wt %, or 10 wt %, preferably about 1 wt % to about 5 wt %.

In the second monomer, the amount of the hydroxyl-containing monomer is not particularly limited and may be adjusted according to an actual application requirement. In some embodiments, by a total amount of all monomers of the acrylic resin, the amount (proportion) of the hydroxyl-containing monomer may be about 10 wt % to about 40 wt %, for example, about 10 wt %, 12 wt %, 14 wt %, 15 wt %, 16 wt %, 18 wt %, 20 wt %, 23 wt %, 24 wt %, 25 wt %, 26 wt %, 28 wt %, 30 wt %, 32 wt %, 34 wt %, 35 wt %, 36 wt %, 38 wt %, or 40 wt %, preferably about 20 wt % to about 30 wt %.

In the second monomer, the amount of the isocyanate-containing monomer is not particularly limited and may be adjusted according to an actual application requirement. In some embodiments, by a total amount of all monomers of the acrylic resin, the amount (proportion) of the isocyanate-containing monomer may be about 3 wt % to about 20 wt %, for example, about 3 wt %, 4 wt %, 5 wt %, 6 wt %, 8 wt %, 10 wt %, 12 wt %, 14 wt %, 15 wt %, 16 wt %, 18 wt %, or 20 wt %, preferably about 7 wt % to about 15 wt %.

The content of the acrylic resin is not particularly limited and may be adjusted according to an actual application requirement. By a total weight (dry weight) of the adhesive composition, the content of the acrylic resin is, for example, but is not limited to, about 92 wt % to about 99.9 wt %, for example, about 92 wt %, 92.5 wt %, 93 wt %, 93.5 wt %, 94 wt %, 94.2 wt %, 94.4 wt %, 94.5 wt %, 94.6 wt %, 94.8 wt %, 95 wt %, 95.2 wt %, 95.4 wt %, 95.5 wt %, 95.6 wt %, 95.8 wt %, 96 wt %, 96.2 wt %, 96.4 wt %, 96.5 wt %, 96.6 wt %, 96.8 wt %, 97 wt %, 97.2 wt %, 97.4 wt %, 97.5 wt %, 97.6 wt %, 97.8 wt %, 98 wt %, 98.5 wt %, 99 wt %, 99.2 wt %, 99.4 wt %, 99.5 wt %, 99.6 wt %, 99.8 wt %, or 99.9 wt %.

### Crosslinking Agent Component of the Adhesive Composition

The crosslinking agent applicable to the present disclosure is not particularly limited. In some embodiments, the crosslinking agent can cause the acrylic resin to undergo thermal crosslinking at 80° C. to 150° C., to allow the adhesive composition to form an adhesive layer after thermal crosslinking. In some embodiments, a suitable crosslinking agent may undergo thermal crosslinking with a hydroxyl group on a side chain of the acrylic resin described herein.

In some specific embodiments, the crosslinking agent may include an isocyanate crosslinking agent, an epoxy crosslinking agent, an aziridine crosslinking agent, a carbodiimide crosslinking agent, a melamine resin crosslinking agent, a urea resin crosslinking agent, an anhydride crosslinking agent, a polyamine crosslinking agent, a carboxyl-containing resin crosslinking agent, or a metal bridging agent, preferably an isocyanate crosslinking agent.

Herein, the “isocyanate crosslinking agent” is an isocyanate component that can undergo a thermal crosslinking reaction with the acrylic resin of the present disclosure to form a crosslinked structure, including but not limited to: an aliphatic cyclic isocyanate compound or an aliphatic non-cyclic isocyanate compound.

The aliphatic cyclic isocyanate compound includes an isocyanate compound having a ring structure other than an aromatic ring, such as but not limited to: isophorone diisocyanate, methylene dicyclohexyl diisocyanate, cyclohexane diisocyanate, derivatives thereof, or reaction products thereof with polyols (for example, trimethylolpropane).

The aliphatic non-cyclic isocyanate compound includes an isocyanate compound with an aliphatic straight or branched chain, such as but not limited to: C₁ to C₂₀ alkylene diisocyanate compounds, derivatives thereof, or reaction products thereof with polyols (for example, trimethylolpropane). The C₁ to C₂₀ alkylene diisocyanate compounds are, for example, but are not limited to: hexamethylene diisocyanate (HDI), 1,2-ethylene diisocyanate, or 1,4-butylene diisocyanate.

The foregoing crosslinking agents may be used alone or in combination.

The content of the crosslinking agent is not particularly limited and may be adjusted according to an actual application requirement. By a total weight (dry weight) of the adhesive composition, the content of the crosslinking agent is, for example, but is not limited to, about 0.01 wt % to 10 wt %, for example, about 0.01 wt %, 0.05 wt %, 0.1 wt %, 0.2 wt %, 0.3 wt %, 0.4 wt %, 0.6 wt %, 0.7 wt %, 0.8 wt %, 0.9 wt %, 1 wt %, 1.2 wt %, 1.4 wt %, 1.5 wt %, 1.6 wt %, 1.8 wt %, 2 wt %, 2.2 wt %, 2.4 wt %, 2.5 wt %, 2.6 wt %, 2.8 wt %, 3 wt %, 4 wt %, 5 wt %, 6 wt %, 7 wt %, 8 wt %, 9 wt %, or 10 wt %.

### Photoinitiator Component of the Adhesive Composition

The photoinitiator contained in the adhesive composition can promote the acrylic resin to undergo light radiation curing. The photoinitiator used in the present disclosure may include a Norrish-type I photoinitiator and a Norrish-type II photoinitiator.

The photoreaction of the Norrish-type I photoinitiator is characterized by the formation of two radical fragments of the original photoinitiator after photolysis. Light radiation causes a homolytic bond to break and produce two highly reactive radical substances, where at least one radical reacts with a repeating unit of the acrylic resin to initiate the polymerization of the acrylic resin.

The photoreaction of the Norrish-type II photoinitiator is characterized by the main photochemical reaction, which is the production of radicals through the interaction between an excited aryl ketone compound and a hydrogen donor. The hydrogen donor molecules usually contain heteroatoms with active hydrogen atoms in the a position. For example, tertiary amines, alcohols, ethers, esters, or thiols are commonly used donors. The molecular structure of the Norrish-type II photoinitiator under ultraviolet radiation does not break but undergoes electron transfer or hydrogen atom transfer, so the molecular weight cannot be lowered.

It has been unexpectedly found that, compared to using the adhesive composition with only the Norrish-type I photoinitiator or the Norrish-type II photoinitiator, using the adhesive composition with both the Norrish-type I photoinitiator and the Norrish-type II photoinitiator can obtain the following beneficial effects: On the premise that the adhesive composition shows a desirable adhesive force (adhesive force>500 g/25 mm) before light radiation curing and shows a good debonding effect (adhesive force<10 g/25 mm) after light radiation curing, fragments of the Norrish-type I photoinitiator have a reduced release content under standard atmospheric conditions or in a wafer cleaning solvent.

A ratio of the content of the Norrish-type II photoinitiator to the content of the Norrish-type I photoinitiator may be adjusted according to an actual application requirement. In some embodiments, by weight, the ratio of the content of the Norrish-type II photoinitiator to the content of the Norrish-type I photoinitiator may be about 0.3 to about 8, for example, but not limited to, about 0.3, 0.4, 0.5, 0.6, 0.7, 0.8, 0.9, 1.0, 1.5, 2, 2.2, 2.4, 2.5, 2.6, 2.8, 3, 3.2, 3.4, 3.5, 3.6, 3.8, 4, 4.2, 4.4, 4.5, 4.6, 4.8, 5, 5.2, 5.4, 5.5, 5.6, 5.8, 6, 6.2, 6.4, 6.5, 6.6, 6.8, 7, 7.2, 7.4, 7.5, 7.6, 7.8, or 8. Usually, when the ratio is low, a good debonding effect can be achieved, but the effect of reducing the release content of fragments is poor; when the ratio is high, a good effect of reducing the release content of fragments can be achieved, but the debonding effect is poor. In some embodiments, to achieve a good balance among the debonding of the composition, the reduction of the release content of fragments, and the curing rate, the ratio of the content of the Norrish-type II photoinitiator to the content of the Norrish-type I photoinitiator is preferably 0.9 to 6.

The Norrish-type I photoinitiator applicable to the present disclosure is not particularly limited, for example but not limited to, selected from the group consisting of acetophenone, 4′-phenoxyacetophenone, 4′-ethoxyacetophenone, hydroxy-acetophenone, α-amino alkyl-phenone, α-dialkoxy-acetophenone, benzyl ketals (or referred to as azoacyl ketals), benzoin ethers and derivatives thereof, benzoylformate esters, phosphine oxides, phenylglyoxylates, oxime, and a mixture thereof.

The suitable hydroxy-acetophenone is, for example, but is not limited to: 3′-hydroxyacetophenone, 4′-hydroxyacetophenone, 1-hydroxycyclohexyl phenyl ketone, or 2-hydroxy-2-methylpropiophenone.

The suitable α-amino alkyl-phenone is, for example, but is not limited to: 2-methyl-4′-(methylthio)-2-morpholinopropiophenone (trade name: Irgacure 907) or 2-benzyl-2-(dimethylamino)-4′-morpholinobutyrophenone (trade name: Irgacure 369).

The suitable α-dialkoxy-acetophenone is, for example, but is not limited to: 2,2-diethoxyacetophenone.

The suitable benzyl ketals are, for example, but are not limited to: 2,2-dimethoxy-2-phenylacetophenone or 2,2-diethoxy-2-phenylacetophenone.

The suitable benzoin ethers and derivatives thereof are, for example, but are not limited to: benzoin, benzoin methyl ether, benzoin ethyl ether, benzoin isobutyl ether, anisoin, benzil, or 4,4′-dimethylbenzil.

The suitable phosphine oxides are, for example, but are not limited to: diphenyl(2,4,6-trimethylbenzoyl) phosphine oxide (TPO) or bis(2,4,6-trimethylbenzoyl)-phenylphosphineoxide (trade name: Irgacure 819).

The suitable oxime is, for example, but is not limited to: 1-phenyl-1,2-propanedione-2-(O-ethoxycarboxy) oxime.

Another suitable Norrish-type I photoinitiator is, for example, but is not limited to: (benzene) tricarbonylchromium, (cumene) cyclopentadienyliron (ii) hexafluorophosphate, ferrocene, methyl benzoylformate, triarylsulfonium hexafluoroantimonate salts, or triarylsulfonium hexafluorophosphate salts.

The foregoing Norrish-type I photoinitiators may be used alone or in combination.

The Norrish-type II photoinitiator applicable to the present disclosure is not particularly limited, for example but not limited to, selected from the group consisting of benzophenone (BP) and a derivative thereof, thioxanthene and a derivative thereof, or anthraquinone and a derivative thereof.

The suitable benzophenone and derivative thereof are, for example, but are not limited to: benzophenone (BP), 4-methylbenzophenone (4-MBP), 4,4′-bis(diethylamino)benzophenone, 2,5-dimethylbenzophenone, 3,4-dimethylbenzophenone, 4,4′-bis(dimethylamino)benzophenone, 4,4′-dihydroxybenzophenone, 4-(dimethylamino)benzophenone, 3-hydroxybenzophenone, 4-hydroxybenzophenone, 2-methylbenzophenone, 3-methylbenzophenone, 3,3′,4,4′-benzophenonetetracarboxylic dianhydride, 3,3′-dimethyl-4-methylbenzophenone, or 4-phenylbenzophenone (PBZ or 4-benzoylbiphenyl).

The suitable thioxanthene and derivative thereof are, for example, but are not limited to: thioxanthene, thioxanthen-9-one, 2-isopropyl-9H-thioxanthen-9-one (2-ITX), 4-isopropyl-9H-thioxanthen-9-one (4-ITX), 2-chlorothioxanthen-9-one, or 2,4-dimethyl-9H-thioxanthen-9-one. It has been unexpectedly found that when the Norrish-type II photoinitiator is the thioxanthene and derivative thereof, it is particularly advantageous for the ratio of the content of the Norrish-type II photoinitiator to the content of the Norrish-type I photoinitiator to be greater than 1, preferably greater than 1.5.

The suitable anthraquinone and derivative thereof are, for example, but are not limited to: anthraquinone, anthraquinone-2-sulfonic acid, or 2-ethylanthraquinone.

Another suitable Norrish-type II photoinitiator is, for example, but is not limited to: camphorquinone, dibenzosuberenone, or phenanthrenequinone.

The foregoing Norrish-type II photoinitiators may be used alone or in combination.

In some preferred embodiments, to achieve a good balance between the debonding and the reduction of the release content of fragments, the combination of the Norrish-type I photoinitiator and the Norrish-type II photoinitiator may be configured to make the energy to excite the Norrish-type II photoinitiator to form a triplet state greater than the energy to excite the Norrish-type I photoinitiator to form a triplet state. In some specific embodiments, the combinations that meet the foregoing conditions are, for example, but not limited to, shown in Table 1:

TABLE 1

| Norrish-type I | Norrish-type II | Amount ratio of |
|---|---|---|
| photoinitiator | photoinitiator | type II/type I |
| TPO | PBZ | 0.9 to 1.2 |
| TPO | BP | 0.8 to 4.5 |
| TPO | 2-ITX | 2.0 to 6.0 |
| TPO | 4-ITX | 2.5 to 7 |
| Irgacure 907 | PBZ | 1.0 to 5.0 |
| Irgacure 907 | BP | 0.8 to 2.0 |
| Irgacure 907 | 2-ITX | 1.5 to 4.0 |
| Irgacure 369 | PBZ | 0.6 to 2.5 |
| Irgacure 369 | BP | 0.6 to 1.2 |
| Irgacure 369 | 2-ITX | 1.5 to 5.5 |
| Irgacure 819 | PBZ | 0.7 to 2.4 |
| Irgacure 819 | BP | 0.6 to 4.5 |
| Irgacure 819 | 2-ITX | 1.5 to 4.8 |

Herein, the absorption wavelength peak of the photoinitiator is determined through measurement on 0.1 wt % of photoinitiator in an acetonitrile solution by a spectrophotometer.

Surprisingly, it has been found that the quenching on a triplet excited state of the Norrish-type II photoinitiator by oxygen may be omitted because the Norrish-type II photoinitiator has a long triplet-state life, which can avoid radical failure in the presence of oxygen, making it easier to remove wafer pieces from a diced wafer in the presence of some oxygen.

Surprisingly, it has also been found that an absorption spectrum of the Norrish-type I photoinitiator may be shielded by a pigment, and the addition of the Norrish-type II photoinitiator can avoid the absorption wavelength of the pigment and effectively transfer the energy to excite a triplet state to the triplet state of the Norrish-type I photoinitiator, thereby increasing the curing rate of the adhesive composition.

The content of the photoinitiator is not particularly limited and may be adjusted according to an actual application requirement. By a total weight (dry weight) of the adhesive composition, the content of the photoinitiator is, for example, but is not limited to, about 0.1 wt % to about 20 wt %, such as but not limited to: 0.1 wt %, 0.2 wt %, 0.4 wt %, 0.5 wt %, 0.6 wt %, 0.8 wt %, 1 wt %, 2 wt %, 4 wt %, 5 wt %, 6 wt %, 8 wt %, 10 wt %, 12 wt %, 14 wt %, 15 wt %, 16 wt %, 18 wt %, 20 wt %, 22 wt %, 24 wt %, 25 wt %, 26 wt %, 28 wt %, or 30 wt %, preferably 0.5 wt % to 10 wt %.

Without prejudice to the purpose of the invention, the adhesive composition may include any conventional additive, such as but not limited to: a crosslinking agent, a tackifier, a filler, a flame retardant, an anti-aging agent, an anti-static agent, a softener, an ultraviolet absorber, an antioxidant, a plasticizer, a surfactant, and a colorant.

In some embodiments, the adhesive composition of the present disclosure may be prepared in the following manner: all the components of the adhesive composition, including the acrylic resin, the crosslinking agent, the photoinitiator, and an additive as required, are mixed uniformly by a stirrer to obtain a mixture, and the obtained mixture is diluted as required with a suitable solvent to a desired concentration for subsequent processing. The solvent may be any inert solvent that can dissolve or disperse the components of the adhesive composition but does not react with the components. The amount of the solvent is not particularly limited, as long as the components of the adhesive composition can be uniformly dissolved or dispersed therein.

The type of radiation for curing the adhesive composition is appropriately set based on the formulation of the adhesive composition. Suitable radiation is from, for example, but is not limited to: a mercury lamp, deep ultraviolet light, ultraviolet light, or visible light. For the adhesive tape to be used in the present disclosure, the radiation is preferably from ultraviolet light with a wavelength of 250 nm to 400 nm. The amount of radiation is not particularly limited, but is only required to cause the selected photoinitiator to undergo a photochemical reaction, for example, but is not limited to: about 10 mJ/cm² to 3000 mJ/cm², preferably about 50 mJ/cm² to 2000 mJ/cm², for example, 350 mJ/cm². An insufficient amount of radiation cannot make the adhesive composition deformed and hardened enough to debond the tape, causing mechanical damage to a target product during peeling. An excessively high amount of radiation makes the adhesive composition brittle to remain on a target product during tape peeling. As used herein, the term “fully curing” means that a sufficient amount of radiation minimizes an adhesive force of the cured adhesive composition.

The substrate may be used to carry the adhesive composition. A suitable form of the substrate is, for example, but is not limited to: a film, a sheet, or a plate. The suitable material of the substrate is, for example, but is not limited to: polyester, polycarbonate, polyethylene, polytetrafluoroethylene, polypropylene, polybutylene, polybutadiene, polyvinyl chloride, polyimide, polysulfone, polyurethane, poly (methyl methacrylate) (PMMA), a polyolefin composite film, or a cycloolefin polymer. The suitable polyester is, for example, but is not limited to: polyethylene terephthalate (PET) or polybutylene terephthalate (PBT). The thickness of the substrate is not particularly limited and may be selected according to an actual application requirement, for example but not limited to: about 25 μm to 150 μm.

The surface of the substrate may be subjected to surface treatment as required before the arrangement of the adhesive composition, which may be physical surface treatment, such as plasma treatment or corona discharge treatment, or may be chemical surface treatment, such as prime coating.

A method for arranging the adhesive composition on the substrate is not particularly limited. For example, the adhesive composition may be coated on the substrate, and heated to cause the adhesive composition to undergo thermal crosslinking to form an adhesive layer. The suitable thickness of the adhesive layer is not particularly limited and may be adjusted according to an actual application requirement, for example but not limited to: about 5 μm to 100 μm. A suitable coating method is not particularly limited, such as but not limited to: gravure coating, roll coating, rod coating, blade coating, slit coating, spray coating, or die coating.

In some embodiments, the adhesive tape may further include a release film disposed on the adhesive composition, to protect the surface of the adhesive composition that is not in contact with the substrate before the adhesive tape is used, avoiding external contamination. The material of the release film is not particularly limited and may be any film material that can be easily separated from the adhesive composition. The thickness of the release film is not particularly limited. Usually, in consideration of costs and providing good protection, the thickness of the release film is about 10 μm to 100 μm. In addition, to make the release film easy to peel off from the adhesive composition, the surface of the release film may be pre-treated, for example but not limited to, treated with silicone or fluorine.

After the adhesive tape is cured by radiation, the adhesive composition with a volume of approximately 36 mm³ generates a fragment content of the photoinitiator in a sealed space of 20 mL under standard conditions, measured by GC-MS, which is about 1 ppm, 1.5 ppm, 2 ppm, 2.5 ppm, 3 ppm, 3.5 ppm, 4 ppm, 4.5 ppm, 5 ppm, 5.5 ppm, 6 ppm, 6.5 ppm, 7 ppm, 7.5 ppm, 8 ppm, 8.5 ppm, 9 ppm, 9.5 ppm, or 10 ppm. The maximum value of a range of the fragment content of the photoinitiator may be any one of the foregoing values, and the minimum value may be any one of the foregoing values. The range of the fragment content of the photoinitiator may also be any combination of the foregoing values, for example, less than 10 ppm. A GC-MS measurement method and related radiation curing parameters of the adhesive tape are shown in examples below.

Therefore, the adhesive tape of the present disclosure provides the following favorable properties:
The adhesive tape has good adhesion and can effectively hold a target product (for example, a wafer) in place, preventing the target product from flying apart during dicing;
the adhesive tape has high resistance to aqueous solutions or solvents, and thus the dissolving-out amount of fragments of the photoinitiator is low;
after light radiation, the adhesive tape is easy to peel off from the target product with little adhesive tape residue left; and
the adhesive tape generates a low fragment content of the photoinitiator when debonded by light radiation.

### EMBODIMENTS

The following further describes in detail the present disclosure through embodiments. It is necessary to point out herein that the following embodiments are only used for further illustration of the present disclosure and cannot be construed as a limitation on the protection scope of the present disclosure. Some non-essential improvements and adjustments to the present disclosure made by a person skilled in the art according to the content of the present disclosure still fall within the protection scope of the present disclosure. Before the discussion of several non-limiting embodiments of the present disclosure, it should be understood that the present disclosure is not limited in its application to the details of the particular non-limiting embodiments shown and described herein, as the present disclosure may have other embodiments. In addition, the terms used herein to describe the present disclosure are for descriptive and non-limiting purposes. Moreover, unless otherwise indicated, the following descriptions of similar numbers refer to similar elements.

Unless otherwise indicated herein, the components contained in a solution, mixture, or composition are calculated by a solid content (dry weight) (that is, a solvent weight is not included).

### Example 1: Preparation of an Adhesive Composition

65 parts by weight of 2-ethylhexyl acrylate, 2 parts by weight of acrylic acid, and 23 parts by weight of 2-hydroxyethyl acrylate were copolymerized by using a conventional method, to obtain an acrylic copolymer. 10 parts by weight of 2-methacryloyloxy ethyl isocyanate (prepared by Showa Denko Materials Co., Ltd. with the trade name of KARENZ MOI) were enabled to react with the acrylic copolymer, to obtain an acrylic resin (with a weight average molecular weight of about 600000).

0.6 parts by weight of isocyanate crosslinking agent Desmodur L75 (prepared by Polyurethane Industry Co., Ltd., Japan), 0.7 parts by weight of Norrish-type I photoinitiator diphenyl(2,4,6-trimethylbenzoyl) phosphine oxide (TPO), and 1.4 parts by weight of Norrish-type II photoinitiator 4-phenylbenzophenone (PBZ) were added to 100 parts by weight of the acrylic resin, mixed and formulated, to obtain the adhesive composition in Sample 1.

Preparation methods for Sample 2 to Sample 7 and Comparative Sample 1 to Comparative Sample 3 are substantially the same as that for Sample 1, with the difference from Sample 1 that: in Sample 2 to Sample 7 and Comparative Sample 1 to Comparative Sample 3, TPO of 0.7 parts by weight used in Sample 1 is correspondingly replaced with the Norrish-type I photoinitiator of the amount listed in Table 2, and PBZ of 1.4 parts by weight used in Sample 1 is correspondingly replaced with the Norrish-type II photoinitiator of the amount listed in Table 2.

TABLE 2

| | Norrish-type I | | Norrish-type II | | |
|---|---|---|---|---|---|
| | photoinitiator | | photoinitiator | | Amount |
| | | Amount | | Amount | ratio of |
| | | (part by | | (part by | type II/ |
| | Name | weight) | Name | weight) | type I |
| Sample 1 | TPO | 0.7 | PBZ | 1.4 | 2 |
| Sample 2 | TPO | 0.8 | PBZ | 1.2 | 1.5 |
| Sample 3 | TPO | 1.2 | PBZ | 0.5 | 0.42 |
| Sample 4 | TPO | 1.5 | PBZ | 0.5 | 0.33 |
| Sample 5 | Irgacure | 1 | 2-ITX | 1 | 1 |
| | 907 | | | | |
| Sample 6 | Irgacure | 0.5 | 2-ITX | 1.5 | 3 |
| | 369 | | | | |
| Sample 7 | TPO | 0.5 | 2-ITX | 2.5 | 5 |
| Comparative | Hycure | 5 | None | 0 | 0 |
| Sample 1 | 1173 | | | | |
| Comparative | TPO | 0.2 | PBZ | 2 | 10 |
| Sample 2 | | | | | |
| Comparative | TPO | 2.5 | PBZ | 0.2 | 0.1 |
| Sample 3 | | | | | |

### Example 2: Preparation of an Adhesive Tape

The adhesive compositions in Sample 1 to Sample 7 and Comparative Sample 1 to Comparative Sample 3 were coated on PET release films respectively. The PET release film includes a poly (ethylene terephthalate) film (with a thickness of 50 μm) that is treated with silicone and that is used as a release liner. The adhesive compositions in Sample 1 to Sample 7 and Comparative Sample 1 to Comparative Sample 3 were dried at 130° C. for 2 min, to form adhesive layers with a thickness of about 60 μm. Then, the obtained adhesive layer was attached to a polyolefin composite film with a thickness of about 90 μm, to obtain the adhesive tape.

### Example 3: Evaluation of an Outgassing Amount of the Adhesive Tape During Debonding by UV Radiation

Each of the adhesive tapes in Sample 1 to Sample 7 and Comparative Sample 1 to Comparative Sample 3 was cut under yellow light into a rectangle of 1.2 cm*5 cm in size (in this case, the volume of the adhesive layer/adhesive composition is about 36 mm³). The rectangle adhesive tape was flattened and fixed in a 20 mL headspace bottle and sealed with a cap, so that the internal space of the headspace bottle formed a gas-tight environment under standard conditions (1 atm, 25° C.). The side of the polyolefin composite film of the adhesive tape was exposed to ultraviolet light at a wavelength of 365 nm and a radiation energy of 350 mJ/cm². After exposure, the adhesive tape was left to stand at room temperature 25° C. for 1 h and then heated at 60° C. for 10 min. The concentration of volatile fragments of the photoinitiator that were produced by the adhesive composition and that were contained in the atmosphere in the headspace bottle was analyzed by GC-MS. The results are shown in Table 3. The quantification of the concentration of volatile fragments of the photoinitiator is as follows: In a measured GC-MS spectrum, one or more mass spectrum peaks corresponding to the photoinitiator used in the adhesive composition are separated, and the area between the mass spectrum peak and a baseline is used for quantification according to an internal standard substance.

TABLE 3

| | Concentration of volatile fragments of the |
|---|---|
| | photoinitiator measured by GC-MS (ppm) |
| Sample 1 | 2.9 |
| Sample 2 | 4.0 |
| Sample 3 | 7.2 |
| Sample 4 | 8.3 |
| Sample 5 | 6.4 |
| Sample 6 | 2.6 |
| Sample 7 | 1.9 |
| Comparative Sample 1 | 28.1 |
| Comparative Sample 2 | 1.5 |
| Comparative Sample 3 | 15.3 |

### Example 4: Evaluation of an Adhesive Force of the Adhesive Tape

Each of the adhesive tapes in Sample 1 to Sample 7 and Comparative Sample 1 to Comparative Sample 3 was cut into a long strip with a width of 25 mm. The long-strip adhesive tape was attached to polished glass in an atmosphere at 1 atm, 25° C., and 50% relative humidity. The test objects were left to stand in the same environment for 20 min, and then adhesive forces before ultraviolet radiation were measured. The results are shown in Table 4. The side of the polyolefin composite film of the adhesive tape was exposed to ultraviolet light at a wavelength of 365 nm and a radiation energy of 350 mJ/cm², and then adhesive forces after ultraviolet radiation were measured. The results are shown in Table 4. The measurement of the adhesive force is as follows: The pressure-sensitive adhesive sheet for dicing is pulled in the direction of peeling at a pulling speed of 300 mm/min, so that the pressure-sensitive adhesive sheet is peeled off at an angle of 180° between the surface of the pressure-sensitive adhesive sheet and the surface of the glass, where a force for peeling is the adhesive force.

TABLE 4

| | Adhesive force before | Adhesive force after |
|---|---|---|
| | ultraviolet radiation | ultraviolet radiation |
| | (g/25 mm) | (g/25 mm) |
| Sample 1 | 530 | 6.2 |
| Sample 2 | 535 | 5.5 |
| Sample 3 | 535 | 4.5 |
| Sample 4 | 534 | 4.0 |
| Sample 5 | 535 | 4.9 |
| Sample 6 | 530 | 5.9 |
| Sample 7 | 531 | 6.8 |
| Comparative Sample 1 | 533 | 3.0 |
| Comparative Sample 2 | 528 | 30.3 |
| Comparative Sample 3 | 532 | 3.5 |

A person skilled in the art understands that various modifications and variations may be made to the present disclosure without departing from the scope or spirit of the present disclosure. In view of the foregoing content, the present disclosure is intended to cover modifications and variations of the present disclosure, with the limitation that they fall within the scope of the patent application and its equivalents.

What is claimed is:

1. An adhesive tape, comprising a substrate and an adhesive composition disposed on the substrate, the adhesive composition comprising an acrylic resin, a crosslinking agent, and a Norrish-type I photoinitiator, wherein after ultraviolet radiation curing at a wavelength of 365 nm, the adhesive composition with a volume of approximately 36 mm³ generates a fragment content of the Norrish-type I photoinitiator in a sealed space of 20 mL under standard conditions, measured by gas chromatography-mass spectrometry, which is less than 10 ppm.

2. The adhesive tape according to claim 1, wherein the adhesive composition further comprises a Norrish-type II photoinitiator.

3. The adhesive tape according to claim 1, wherein the Norrish-type I photoinitiator comprises acetophenone, 4′-phenoxyacetophenone, 4′-ethoxyacetophenone, hydroxy-acetophenone, α-amino alkyl-phenone, α-dialkoxy-acetophenone, benzyl ketals, benzoin ethers and derivatives thereof, benzoylformate esters, phosphine oxides, phenylglyoxylates, oxime, or a mixture thereof.

4. The adhesive tape according to claim 2, wherein the Norrish-type II photoinitiator comprises benzophenone and a derivative thereof, thioxanthene and a derivative thereof, anthraquinone and a derivative thereof, or a mixture thereof.

5. The adhesive tape according to claim 2, wherein a ratio of the Norrish-type II photoinitiator to the Norrish-type I photoinitiator is 0.3 to 8 by weight.

6. The adhesive tape according to claim 5, wherein the ratio of the Norrish-type II photoinitiator to the Norrish-type I photoinitiator is >1 to 6 by weight.

7. The adhesive tape according to claim 3, wherein the Norrish-type I photoinitiator is one or more selected from the group consisting of acetophenone, 1-hydroxycyclohexyl phenyl ketone, 4′-phenoxyacetophenone, 3′-hydroxyacetophenone, 4′-hydroxyacetophenone, anisoin, (benzene) tricarbonylchromium, benzil, benzoin, benzoin methyl ether, benzoin ethyl ether, benzoin isobutyl ether, 2-benzyl-2-(dimethylamino)-4′-morpholinobutyrophenone, (cumene)cyclopentadienyliron(ii) hexafluorophosphate, 2,2-diethoxyacetophenone, 2,2-dimethoxy-2-phenylacetophenone, 2,2-diethoxy-2-phenylacetophenone, 4,4′-dimethylbenzil, diphenyl(2,4,6-trimethylbenzoyl) phosphine oxide, 2-hydroxy-2-methylpropiophenone, 4′-ethoxyacetophenone, ferrocene, methyl benzoylformate, 2-methyl-4′-(methylthio)-2-morpholinopropiophenone, triarylsulfonium hexafluoroantimonate salts, triarylsulfonium hexafluorophosphate salts, 2-benzyl-2-dimethylamino-1-(4-morpholinophenyl)-butanone-1, bis(2,4,6-trimethylbenzoyl)-phenylphosphine oxide, and 1-phenyl-1,2-propanedione-2-(O-ethoxycarboxy) oxime.

8. The adhesive tape according to claim 4, wherein the Norrish-type II photoinitiator is one or more selected from the group consisting of anthraquinone, anthraquinone-2-sulfonic acid, benzophenone, 3,3′,4,4′-benzophenonetetracarboxylic dianhydride, 4,4′-bis(diethylamino)benzophenone, 4,4′-bis(dimethylamino)benzophenone, camphorquinone, 2-chlorothioxanthen-9-one, dibenzosuberenone, 4,4′-dihydroxybenzophenone, 4-(dimethylamino)benzophenone, 2,5-dimethylbenzophenone, 3,4-dimethylbenzophenone, 2-ethylanthraquinone, 3-hydroxybenzophenone, 4-hydroxybenzophenone, 2-methylbenzophenone, 3-methylbenzophenone, phenanthrenequinone, 2-isopropyl-9H-thioxanthen-9-one, 3,3′-dimethyl-4-methylbenzophenone, 4-phenylbenzophenone, 4-isopropyl-9h-thioxanthen-9-one, 2,4-dimethyl-9h-thioxanthen-9-one, thioxanthene, and thioxanthen-9-one.

9. The adhesive tape according to claim 1, wherein a monomer forming the acrylic resin comprises one or more first monomers and one or more second monomers different from the one or more first monomers, the one or more first monomers being selected from the group consisting of alkyl esters of (meth)acrylic acid, cycloalkyl esters of (meth)acrylic acid, and aryl esters of (meth)acrylic acid.

10. The adhesive tape according to claim 9, wherein the one or more second monomers comprise a carboxyl-containing monomer, a hydroxyl-containing monomer, and an isocyanate-containing monomer.
